(19) United States
(12) Patent Application Publication
(10) Pub. No.: US 2008/0180609 A1
(43) Pub. Date: Jul. 31, 2008

(54) LIQUID CRYSTAL DISPLAY

(76) Inventors: Seong-Chul Hong, Seoul (KR); Joo-Hwan Shim, Hwaseong-si (KR)

Correspondence Address: F. CHAU & ASSOCIATES, LLC, 130 WOODBURY ROAD, WOODBURY, NY, 11797, US

(21) Appl. No.: 11/934,550

(22) Filed: Nov. 2, 2007

(30) Foreign Application Priority Data
Jan. 25, 2007 (KR) 10-2007-0007763

(51) Int. Cl. G02F 1/1339; G02F 1/1335

(52) U.S. Cl. 349/106; 349/156

(57) ABSTRACT

A liquid crystal display (LCD) includes a substrate, a light blocking member formed on the substrate, an alignment layer formed on the substrate; and a column spacer formed on the light blocking member, wherein a cross-section of the column spacer includes a first edge facing a rubbing direction of the alignment layer and has at least one straight line part, and a second edge forming the rest of the cross-section excluding the first edge, and the straight line part of the first edge and the rubbing direction of the alignment layer form an acute angle.

### CROSS-REFERENCE TO RELATED APPLICATION

This application claims priority to Korean Patent Application No. 10-2007-0007763 filed on Jan. 25, 2007, the contents of which are incorporated herein by reference in their entirety.

### BACKGROUND OF THE INVENTION

(a) Technical Field

The present disclosure relates to a liquid crystal display, and more particularly to a liquid crystal display for reducing an edge image retention while preventing an aperture ratio from being decreased.

(b) Discussion of the Related Art

Liquid crystal displays (LCDs) are flat panel displays. LCDs include two panels on which field generating electrodes and polarizers are disposed, and a liquid crystal layer interposed between the panels. In the LCD, a voltage is applied to the field generating electrodes to generate an electric field in the liquid crystal layer. Then, the alignment of liquid crystal modules of the liquid crystal layer is determined by the electric field to control the polarization of incident light, thereby displaying images.

In a rubbing vertically aligned (RVA) mode LCD, liquid crystals are vertically arranged while rubbing an alignment layer. In the RVA mode LCD, a contrast ratio is large and a reference viewing angle is wide.

However, unlike a typical VA mode LCD, the RVA mode LCD has a image retention appearing at lateral sides of the LCD due to the rubbing operation.

Liquid crystals aligned in the rubbing direction are re-aligned when an electric field is applied to the LCD, and then the liquid crystals are aligned in the rubbing direction again after the electric field is eliminated. Liquid crystals in an area where the rubbing direction is opposite to the electric field direction cannot be quickly aligned again to the rubbing direction when the electric field is eliminated due to a column spacer. This may cause a image retention. The image retention may be observed in a main viewing angle direction, which is the rubbing direction, and may not be observed in other directions.

The image retention appearing at the lateral sides can be eliminated by widening a light blocking member. However, the entire aperture ratio can be decreased as the light blocking member becomes wider.

### SUMMARY OF THE INVENTION

According to an exemplary embodiment of the present invention, a liquid crystal display (LCD) comprises a substrate, a light blocking member formed on the substrate, an alignment layer formed on the substrate, and a column spacer formed on the light blocking member, wherein a cross-section of the column spacer includes a first edge facing a rubbing direction of the alignment layer and has at least one straight line part, and a second edge forming the rest of the cross-section excluding the first edge, and the straight line part of the first edge and the rubbing direction of the alignment layer form an acute angle.

The acute angle can be less than or equal to about 15 degrees.

The first edge of the column spacer may include two edges of a triangle and a vertex where the two edges of the triangle meet, and the second edge of the column spacer comprises an arc.

The cross-section of the column spacer can be triangular shaped.

The cross-section of the column spacer can be rhombus shaped.

The first edge of the column spacer may include two edges of a triangle and a curved line part where the two edges meet, and the second edge of the column spacer comprises an arc.

According to an exemplary embodiment of the present invention, a liquid crystal display (LCD) comprises a first substrate, a gate line and a data line formed on the first substrate, a thin film transistor connected with the gate line and the data line, a pixel electrode connected with the thin film transistor, a second substrate facing the first substrate, a common electrode formed on the second substrate, a liquid crystal layer interposed between the first and second substrates, the liquid crystal layer including liquid crystal molecules, an alignment layer interposed between the liquid crystal layer and at least one of the first substrate and the second substrate, the alignment layer aligning the liquid crystal molecules, and a column spacer interposed between the first substrate and the second substrate, wherein a cross-section of the column spacer includes a first edge facing a rubbing direction of the alignment layer and has at least one straight line part, and a second edge including the rest of the cross-section excluding the first edge, and the straight line part of the first edge and the rubbing direction of the alignment layer form an acute angle.

The acute angle can be less than or equal to about 15 degrees.

A light blocking member can be formed between the second substrate and the common electrode.

The first edge of the column spacer may include two edges of a triangle and a vertex where the two edges of the triangle meet, and the second edge of the column spacer comprises an arc.

A red color filter, a green color filter, and a blue color filter can be formed in a triangular configuration on the second substrate, wherein the column spacer is formed at a location contacting each of the red color filter, the green color filter, and the blue color filter.

The first edge of the column spacer may include two edges of a triangle and a curved line part where the two edges meet, and the second edge of the column spacer comprises an arc.

A red color filter, a green color filter, and a blue color filter can be formed in a triangular configuration on the second substrate, wherein the column spacer is formed at a location contacting each of the red color filter, the green color filter, and the blue color filter.

### BRIEF DESCRIPTION OF THE DRAWINGS

Exemplary embodiments of the present invention can be understood in more detail from the following descriptions taken in conjunction with the accompanying drawings, in which:

FIG. 1 is a layout view of a liquid crystal display (LCD) according to an exemplary embodiment of the present invention;

FIG. 2 is a cross-sectional view taken along the line II-II of FIG. 1;

FIG. 3 is a view illustrating an alignment state of a rubbing direction of an alignment layer in a color filter array panel and a column spacer according to an exemplary embodiment of the present invention;

FIG. 4 shows a column spacer according an exemplary embodiment of the present invention;

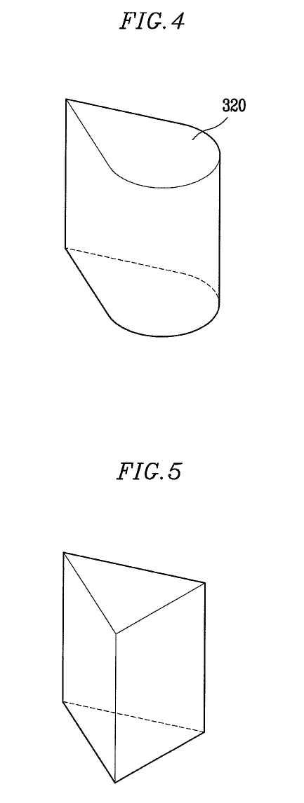

FIG. 5 to FIG. 7 show a column spacer according to exemplary embodiments of the present invention; and

FIG. 8 is a layout view of an LCD according to an exemplary embodiment of the present invention.

### DETAILED DESCRIPTION OF EXEMPLARY EMBODIMENTS

Exemplary embodiments of the present invention will be described below in more detail with reference to the accompanying drawings. The present invention may, however, be embodied in many different forms and should not be construed as limited to the exemplary embodiments set forth herein.

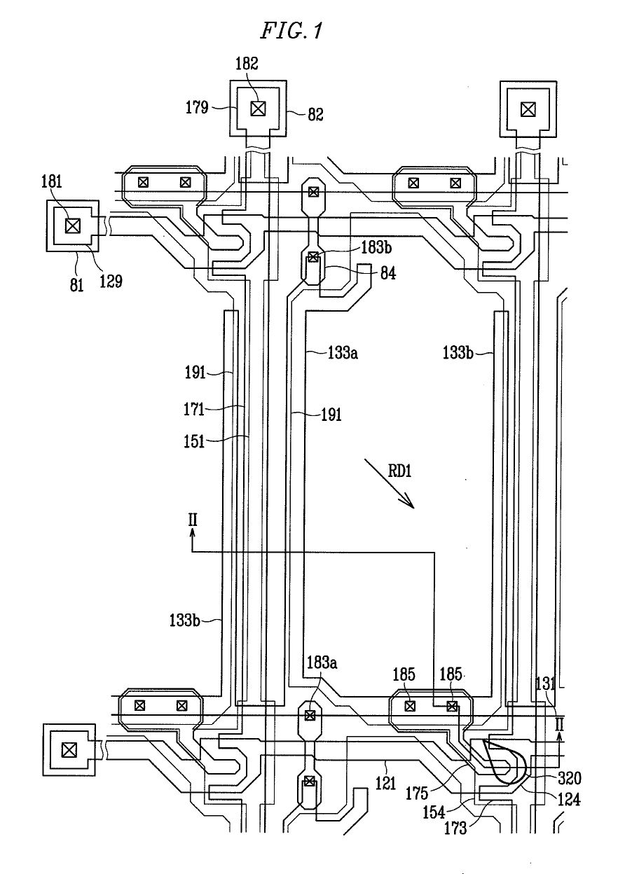

It will be understood that when an element such as a layer, film, region, or substrate is referred to as being “on” another element, it can be directly on the other element or intervening elements may also be present. A color filter array panel for a liquid crystal display (LCD) and an LCD having the color filter array panel according to an exemplary embodiment of the present invention are described with reference to FIG. 1 to FIG. 3.

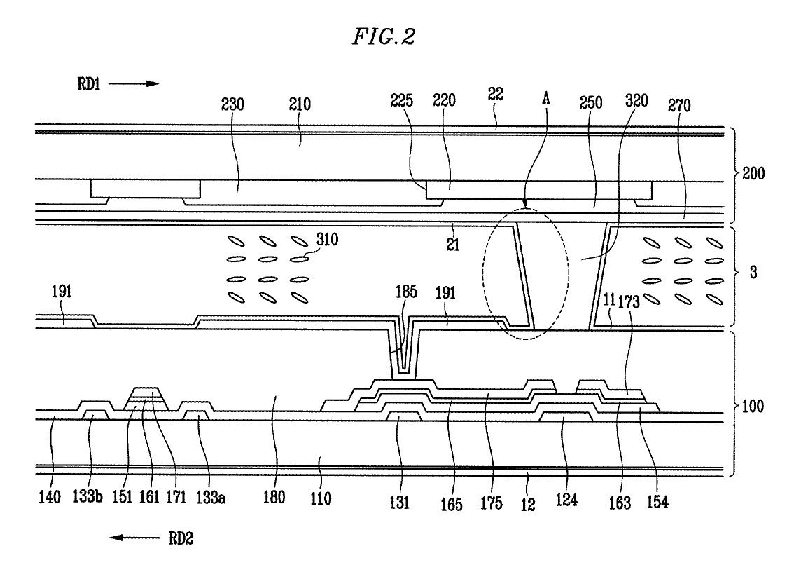

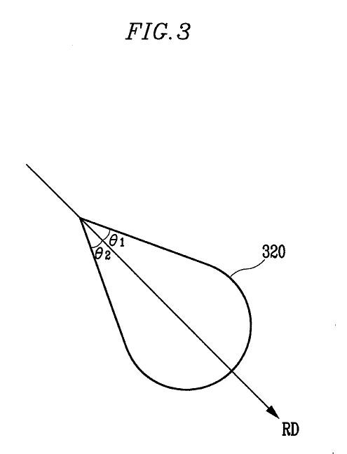

FIG. 1 is a layout view of an LCD according to an exemplary embodiment of the present invention. FIG. 2 is a cross-sectional view taken along the line II-II of FIG. 1. FIG. 3 is a view illustrating an alignment state of a rubbing direction of an alignment layer in a color filter array panel and a column spacer according to an exemplary embodiment of the present invention.

The LCD according to an exemplary embodiment of the present invention includes a thin film transistor (TFT) array panel 100 and a color filter array panel 200 facing each other, a liquid crystal layer 3 interposed between the TFT array panel 100 and the color filter array panel 200, and lower and upper polarizers 12 and 22 formed on an external surface of the two panels 100 and 200.

A plurality of gate lines 121 and a plurality of storage electrode lines 131 are formed on an insulation substrate 110. The insulation substrate 110 may comprise, for example, transparent glass or plastic.

Each gate line 121 extends substantially in a horizontal direction, and transmits a gate signal. Each gate line 121 includes a plurality of downwardly protruded gate electrodes 124 and a wide end portion 129 for connecting, for example, a different layer or an external driving circuit.

A predetermined voltage is applied to the storage electrode lines 131. Each storage electrode line 131 includes a trunk line extending substantially parallel to the gate lines 121, and a plurality of first and second storage electrodes 133a and 133b branched from the trunk line. The storage electrodes 133a and 133b respectively include a fixed end connected to the trunk line and a free end disposed opposite the fixed end. The shape and arrangement of the storage electrode lines 131 may be modified in various different ways.

On the gate lines 121 and the storage electrode lines 131, a gate insulating layer 140 comprising, for example, silicon nitride (SiNx) or silicon oxide (SiOx) is formed.

On the gate insulating layer 140, a plurality of semiconductor stripes 151 comprising, for example, hydrogenated amorphous silicon (hydrogenated a-Si) or polysilicon are formed. The semiconductor stripes 151 extend substantially in a vertical direction and have a plurality of projections 154 protruding toward the gate electrodes 124. A plurality of ohmic contact stripes and islands (“ohmic contacts”) 161 and 165 are formed on the semiconductor stripes 151. The ohmic contacts 161 and 165 may comprise a material such as, for example, n+ hydrogenated amorphous silicon that is heavily doped with an n-type impurity such as phosphorous, or silicide. Each of the ohmic contact stripes 161 has a plurality of projections 163, and a pair of a projection 163 and an ohmic contact island 165 is disposed on each projection 154 of the semiconductor stripes 151.

On the ohmic contacts 161, 163, and 165 and the gate insulating layer 140, a plurality of data lines 171 and a plurality of drain electrodes 175 are formed.

The data lines 171 transfer data signals, and extend substantially in a vertical direction to intersect the gate lines 121. Each of the data lines 171 has a plurality of source electrodes 173 extending toward the gate electrodes 124 and a wide end portion 179 for connecting with, for example, another layer or an external driving circuit.

The drain electrodes 175 are formed to be separated from the data lines 171, and face the source electrodes 173 with the gate electrodes 124 interposed therebetween.

One gate electrode 124, one source electrode 173, and one drain electrode 175 form a single TFT along with one projection 154 of the semiconductor stripes 151. A channel of the TFT is formed on the projection 154 between the source electrode 173 and the drain electrode 175.

The ohmic contacts 161, 163, and 165 are formed between the semiconductor stripes 151 and 154 positioned under the ohmic contacts 161, 163, and 165, and the data lines 171 and drain electrodes 175 positioned on the ohmic contacts 161, 163, and 165 to reduce the contact resistance therebetween. A passivation layer 180 is formed on the data lines 171, the drain electrodes 175, and exposed portions of the semiconductor stripes 151. The passivation layer 180 can be formed of an inorganic insulator or an organic insulator, and may have a flat surface.

A plurality of contact holes 182 and 185 respectively exposing the end portions 179 of the data lines 171 and the drain electrodes 175 are formed in the passivation layer 180. A plurality of contact holes 181 exposing the end portions 129 of the gate lines 121, a plurality of contact holes 183a partially exposing the storage electrode lines 131 located close to the fixed end of the first storage electrodes 133a, and a plurality of contact holes 183b partially exposing ends of the free ends of the first storage electrodes 133a are formed in the passivation layer 180 and the gate insulating layer 140.

A plurality of pixel electrodes 191, a plurality of overpasses 84, and a plurality of contact assistants 81 and 82 are formed on the passivation layer 180. The pixel electrodes 191 are physically and electrically connected to the drain electrodes 175 through the contact holes 185, and a data voltage is applied from the drain electrodes 175 to the pixel electrodes 191. The pixel electrodes 191 receiving the data voltage form an electric field along with a common electrode 270 of the color filter array panel 200 receiving the common voltage to thereby determine the alignment of the liquid crystal molecules of the liquid crystal layer 3 interposed between the two electrodes 191 and 270.

The contact assistants 81 and 82 are respectively connected with the end portions 129 of the gate lines 121 and the end portions 179 of the data lines 171 through the respective contact holes 181 and 182.

The overpasses 83 cross the gate lines 121 and are connected to the exposed portions of the storage electrodes 131 and the exposed ends of the free ends of the storage electrodes 133a through contact holes 183a and 183b. The contact holes 183a and 183b are formed opposite each other with respect to the gate lines 121.

The color filter array panel 200 is described with reference to FIG. 2 and FIG. 3.

A light blocking member 220 is formed on an insulation substrate 210 comprising, for example, transparent glass or plastic. The light blocking member 220 can be, for example, a black matrix.

The light blocking member 220 faces the pixel electrodes 191 and has a plurality of openings 225 having substantially the same shape as the pixel electrodes 191. The light blocking member 220 prevents light leakage between the pixel electrodes 191. The light blocking member 220 may have portions corresponding to the gate lines 121 and the data lines 171, and portions corresponding to the TFTs.

A plurality of color filters 230 are formed on the substrate 210.

An overcoat 250 is formed on the color filter 230 and the light blocking member 220. The overcoat 250 may comprise an organic insulating member. The overcoat 250 prevents the color filters 230 from being exposed to the outside, and provides a flat surface. The overcoat 250 may be omitted according to an exemplary embodiment of the present invention.

A common electrode 270 is formed on the overcoat 250.

A column spacer 320 for maintaining a constant gap between the two panels 100 and 200 is formed on the common electrode 270. The column spacer 320 is formed on a portion which is not used to display an image because an opaque thin film is formed on the portion. A cross-sectional area of the column spacer 320 becomes gradually decreased toward the TFT array panel 100 from the color filter array panel 200. However, the cross-sectional area of the column spacer 320 may be constant according to an exemplary embodiment of the present invention. The column spacer 320 may be formed on the pixel electrode 191 of the TFT array panel 100. The cross-section of the column spacer 320 can be configured to prevent occurrence of a image retention.

Lower and upper alignment layers 11 and 21 are coated on an inner surface of the display panels 100 and 200, and are rubbed. In FIG. 1 to FIG. 3, an arrow RD1 shows a rubbing direction of the upper alignment layer 21, and an arrow RD2 shows a rubbing direction of the lower alignment layer 11. The rubbing directions RD1 and RD2 of the upper and lower alignment layers 21 and 11 are opposite to each other, for example, as shown in FIG. 2. In an exemplary embodiment, the image retention is observed in the rubbing direction RD1 of the upper alignment layer 21 formed on the color filter array panel 200. This direction (RD1) is referred to as a main viewing angle direction.

The liquid crystal molecules 310 of the liquid crystal layer 3 are vertically aligned with respect to the two panels 100 and 200 when there is no electric field generated. The liquid crystal molecules 310 are sloped with a pre-tilt angle in the rubbing directions RD1 and RD2 at portions where the liquid crystal molecules 310 contact the upper and lower alignment layers 21 and 11, and the liquid crystal molecules 310 in the center portion of the liquid crystal layer 3 are vertically aligned with respect to the two panels 100 and 200. When the electric field is applied, the liquid crystal molecules 310 lean to the rubbing directions RD1 and RD2. According to an exemplary embodiment of the present invention, since the slope directions of the liquid crystal molecules 310 are controlled when the electric field is applied, a moving speed of the liquid crystal molecules 310 is fast and a viewing angle is wide. However, the liquid crystal molecules 310 near the column spacer 320 are prevented from leaning in the rubbing directions RD1 and RD2.

According to an exemplary embodiment of the present invention, the cross-section of the column spacer 320 may be formed in a combined shape of a triangle and an ellipse to reduce an area A where the liquid crystal molecules 310 cannot lean in the rubbing directions RD1 as shown in FIG. 1 to FIG. 3. That is, a cross-section of a column spacer 320 facing the rubbing direction RD comprises two edges of a triangle and a vertex of the two edges, and a cross-section that does not face the rubbing direction RD comprises an arc of an ellipse. Hereinafter, the edge of the cross-section facing the rubbing direction RD is referred to as a “counter edge”, and the edge of the cross-section that does not face the rubbing direction RD is referred to as a “non-counter edge”.

In an exemplary embodiment, the two edges of the triangle, forming the counter edge of the column spacer 320, and the rubbing direction RD respectively form acute angles Θ₁ and Θ₂, wherein both angles Θ₁ and Θ₂ are less than about 15°. This is to prevent the column spacer 320, which faces the liquid crystal molecules 310, from preventing the liquid crystal molecules 310 from leaning in the rubbing direction RD because the orientation of the liquid crystal molecules 310 is disheveled when the acute angles Θ₁ and Θ₂ formed by the counter edge and the rubbing direction are greater than about 15°.

The non-counter edge of the column spacer 320 may be formed in various shapes. In an exemplary embodiment, the non-counter edge of the column spacer 320 comprises an ellipse to reduce a portion standing against the rubbing direction RD and to prevent a cross-sectional area of the column spacer 320 from being reduced.

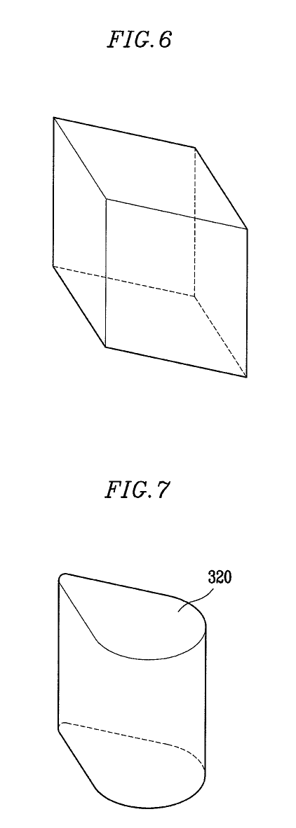

The shape of the column spacer 320 can be formed such as, for example, a triangle or a rhombus as shown in FIG. 5 and FIG. 6. An area of the column spacer 320 standing against the rubbing direction RD is reduced and the cross-sectional area of the column spacer 320 can be maintained. In an exemplary embodiment, as shown in FIG. 7, the vertex of the counter edge can be rounded, that is, the counter edge can be formed by two edges of the triangle and a curved line part where the two edges meet. In this exemplary embodiment, the vertex part of the column spacer 320 can be prevented from being damaged due to pressure.

In an exemplary embodiment, when the column spacer 320 is formed in a location where two edges of a triangle, forming the counter edge, are inclined at less than about 15 degrees with respect to the rubbing direction RD1, liquid crystals can lean in the rubbing direction RD1, thereby reducing the region A where a image retention occurs.

The polarizers 12 and 22 are formed on the external surface of the panels 100 and 200. In an exemplary embodiment, polarization axes of the two polarizers 12 and 22 orthogonally cross one another and one of the two polarization axes is parallel to the gate lines 121. In an exemplary embodiment, acute angles formed by the polarization axes of the two polarizers 12 and 22 and the rubbing directions RD1 and RD2 of the two alignment layers 11 and 21 are about 45°. When the LCD is provided as a reflective LCD, one of the two polarizers 12 and 22 can be omitted.

The LCD according to an exemplary embodiment of the present invention may further include a phase retardation film (not shown) for compensating for the delay of the liquid crystal layer 3. The LCD may include a backlight unit (not shown) for supplying light to the polarizers 12 and 22, the phase retardation film, the display panels 100 and 200, and the liquid crystal layer 3.

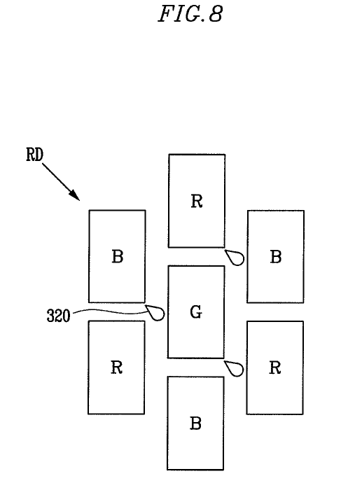

FIG. 8 is a layout view of an LCD according to an exemplary embodiment of the present invention.

As shown in FIG. 8, pixels in neighboring pixel columns can be alternately disposed in the LCD according to an exemplary embodiment. That is, a green pixel G of a second pixel column is disposed between a blue pixel B and a red pixel R of a first pixel column, and a blue pixel B of the first pixel column is disposed between a red pixel R and a green pixel G of the second pixel column. In this exemplary embodiment, a red pixel R, a green pixel G, and a blue pixel B, aligned forming a triangular shape in two adjacent pixel arrays, are used as a unit for one dot.

In a pixel alignment according to an exemplary embodiment, the column spacer 320 is disposed on a location contacting all of the red pixel R, the greed pixel G, and the blue pixel B aligned in the triangular shape and used as the unit for one dot. The location where the column spacer 320 is formed is an area which is not used for displaying an image and which allows a high degree of freedom in disposing the column spacer 320.

To reduce a portion of the column spacer 320 facing the liquid crystal molecules, two edges of a triangle, forming the counter edge of the column spacer 320, are disposed to make angles that are less than about 15 degrees with respect to the rubbing direction RD.

According to an exemplary embodiment of the present invention, occurrence of a image retention appearing at lateral sides of the LCD can be reduced by reducing a portion of a column spacer of the LCD facing the rubbing direction.

Although exemplary embodiments of the present invention have been described herein with reference to the accompanying drawings, it is to be understood that the present invention should not be limited to those precise embodiments and that various other changes and modifications may be made by one of ordinary skill in the related art without departing from the scope or spirit of the invention. All such changes and modifications are intended to be included within the scope of the invention as defined by the appended claims.

What is claimed is:

1. A liquid crystal display (LCD) comprising:
a substrate;
a light blocking member formed on the substrate;
an alignment layer formed on the substrate; and
a column spacer formed on the light blocking member,
wherein a cross-section of the column spacer includes a first edge facing a rubbing direction of the alignment layer and has at least one straight line part, and a second edge forming the rest of the cross-section excluding the first edge, and the straight line part of the first edge and the rubbing direction of the alignment layer form an acute angle.

2. The LCD of claim 1, wherein the acute angle is less than or equal to about 15 degrees.

3. The LCD of claim 1, wherein the first edge of the column spacer includes two edges of a triangle and a vertex where the two edges of the triangle meet, and the second edge of the column spacer comprises an arc.

4. The LCD of claim 1, wherein the cross-section of the column spacer is triangular shaped.

5. The LCD of claim 1, wherein the cross-section of the column spacer is rhombus shaped.

6. The LCD of claim 1, wherein the first edge of the column spacer includes two edges of a triangle and a curved line part where the two edges meet, and the second edge of the column spacer comprises an arc.

7. A liquid crystal display (LCD) comprising:
a first substrate;
a gate line and a data line formed on the first substrate;
a thin film transistor connected with the gate line and the data line;
a pixel electrode connected with the thin film transistor;
a second substrate facing the first substrate;
a common electrode formed on the second substrate;
a liquid crystal layer interposed between the first and second substrates, the liquid crystal layer including liquid crystal molecules;
an alignment layer interposed between the liquid crystal layer and at least one of the first substrate and the second substrate, the alignment layer aligning the liquid crystal molecules; and
a column spacer interposed between the first substrate and the second substrate,
wherein a cross-section of the column spacer includes a first edge facing a rubbing direction of the alignment layer and has at least one straight line part, and a second edge including the rest of the cross-section excluding the first edge, and the straight line part of the first edge and the rubbing direction of the alignment layer form an acute angle.

8. The LCD of claim 7, wherein the acute angle is less than or equal to about 15 degrees.

9. The LCD of claim 7, further comprising a light blocking member formed between the second substrate and the common electrode.

10. The LCD of claim 7, wherein the first edge of the column spacer includes two edges of a triangle and a vertex where the two edges of the triangle meet, and the second edge of the column spacer comprises an arc.

11. The LCD of claim 10, further comprising a red color filter, a green color filter, and a blue color filter formed in a triangular configuration on the second substrate,
wherein the column spacer is formed at a location contacting each of the red color filter, the green color filter, and the blue color filter.

12. The LCD of claim 7, wherein the first edge of the column spacer includes two edges of a triangle and a curved line part where the two edges meet, and the second edge of the column spacer comprises an arc.

13. The LCD of claim 12, further comprising a red color filter, a green color filter, and a blue color filter formed in a triangular configuration on the second substrate, wherein the column spacer is formed at a location contacting each of the red color filter, the green color filter, and the blue color filter.
